(19) United States
(12) Patent Application Publication
(10) Pub. No.: US 2026/0276790 A1
(43) Pub. Date: Sep. 17, 2026

(54) HOUSING FOR OPTICAL ELEMENTS OF AN OPTICAL RECEIVER, OPTICAL RECEIVER WITH HOUSING AND LIDAR SYSTEM WITH OPTICAL RECEIVER

(71) Applicant: Valeo Detection Systems GmbH, Bietigheim-Bissingen (DE)

(72) Inventors: Haiyue Yang, Bietigheim-Bissingen (DE); Thorsten Beuth, Bietigheim-Bissingen (DE)

(73) Assignee: Valeo Detection Systems GmbH, Bietigheim-Bissingen (DE)

(21) Appl. No.: 19/167,565

(22) PCT Filed: Mar. 7, 2024
(86) PCT No.: PCT/EP2024/056028

§ 371 Date: Sep. 22, 2025

(30) Foreign Application Priority Data
Mar. 22, 2023 (DE) 10 2023 107 171.8

(51) Int. Cl. G01S 7/481; G01S 17/931; G02B 5/20; G02B 7/00

(52) U.S. Cl. CPC G01S 7/4816; G01S 7/4817; G01S 17/931; G02B 5/20; G02B 7/006

(57) ABSTRACT

Described is a housing for optical elements of an optical receiver of a system. The optical elements are configured to be placed in a reception path of an optical reception signal of the optical receiver and to influence the optical reception signal of the optical receiver. The housing includes an asymmetrical shape with at least a partial reduction such that the intensity of the reception signal received from a high incident angle is increased.

### FIELD

The present disclosure relates to the field of optical detection and ranging systems, in particular lidar systems. An optical detection and ranging system comprises an optical receiver with optical elements and may comprise a housing. Optical detection and ranging systems may be applied in the automotive field.

### BACKGROUND

Modern vehicles (cars, vans, trucks, motorcycles, etc.) have a large number of sensor systems whose data are used for driver information and/or are made available to driver assistance systems. The sensor systems may detect the vehicle's environment and other road users within their detection area. Based on the data collected, a model of the vehicle's environment may be generated, and the system may react to changes in this vehicle environment. The sensor systems may also detect the distance to objects in the vehicle's environment and relative speed of the objects to the vehicle.

An important sensor principle for the detection of the environment of e. g. vehicles is the lidar technology (lidar: Light Detection and Ranging). A lidar system has an optical transmitter and an optical receiver. The transmitter can emit an optical transmit signal. In a lidar system, the light used can be laser light in the ultraviolet, visual or infrared range. The optical receiver can receive the emitted light as an optical reception signal after reflection from an object in detection area of the lidar system. A control unit of the lidar system may detect objects within the detection area of the lidar system using the transmit signal and the reception signal. A distance to the object and/or relative speed to the object and/or other properties may be obtained using the transmit signal and the reception signal.

Optical elements used within an optical receiver comprise at least one optical lens element and a bandpass filter. The bandpass filter allows to filter out optical signals with a wavelength outside of its passband. The bandpass filter may be designed to let optical signals pass, which comprise wavelengths within the operation range of the lidar system.

### SUMMARY

A system, in particular a lidar system, comprises a housing for optical elements of an optical receiver of the system. The optical elements are configured to be placed in a reception path of an optical reception signal of the optical receiver and to influence the optical reception signal of the optical receiver. The housing comprises an asymmetrical shape with at least a partial reduction such that the intensity of the reception signal received from a high incident angle is increased. The intensity of an optical signal corresponds to the amount of light that is received.

The optical sensor element is configured to capture the light of the incoming optical signal and to transform it into an electrical signal. The optical elements may comprise an optical lens element and an optical bandpass filter, wherein the lens element is located in the reception path of the reception signal in between the bandpass filter and an optical sensor element of the optical receiver. The described location of the bandpass filter in relation to the lens element and the sensor element has the advantage that undesired optical effects, such as blooming and/or ghosting, may be reduced, because the bandpass filter may be arranged that reflections on the bandpass filter will be captured by the optical sensor element to a lesser extent.

The bandpass filter may comprise a planar body. The shape of the bandpass filter may itself be asymmetrical with respect to certain spatial direction, e. g. be of a nearly rectangular shape or a shell shape.

The housing may further comprise a holding element, which is configured to hold the bandpass filter at edges of the planar body, wherein a first and a second part of the holding element are located opposite each other in a first direction, wherein the first and the second part are asymmetrical with respect to each other. The shape of the first part being asymmetrical to the second part contributes to the asymmetrical shape of the housing. In particular, the first part may be extruding less from a body of the housing than the second part, so that the extension of the first part contributes to the partial reduction of the housing.

In embodiments of the housing, the holding element of the housing is configured to hold the planar body of the bandpass filter, which is tilted with respect to the first direction and/or with respect to the reception path. The asymmetry of the holding element then depends on the tilt of the planar body.

In embodiment of the housing the second part of the holding element is configured to hold the planar body farther away from the lens element than the first part of the holding element. The second part may in particular be thicker than the first part in the first direction, the first part thereby contributing to the at least partial reduction of the housing. Additionally and/or alternatively, the second part may extend further than the first part along the reception path, the first part thereby contributing to the at least partial reduction of the housing.

In further embodiments of the housing, further holding parts of the holding element are configured to hold the planar body of the bandpass filter at edges opposing each other in a second direction, wherein the spatial extension along the reception path of each of the first and the second part is smaller than the spatial extension along the reception path of the further holding parts.

The second part may be thicker than the first part with respect to the first direction. The spatial extension along the reception path of the second part may be larger than the spatial extension along the reception path of the first part. This may result in an asymmetrical shape of the bandpass filter as well. This may also result in an asymmetrical arrangement of the bandpass filter with respect to the optical lens and/or the housing.

The optical receiver comprises the housing as described previously. The optical receiver further comprises the optical elements and the optical sensor element. The optical sensor element is configured to capture the optical reception signal, which has passed through the optical elements placed in the reception path of the reception signal. The optical sensor element may for example be at least one photodiode with the surface to capture the light of the optical signal. The optical elements comprise at least one lens element and at least one bandpass filter.

The sensor element comprises a surface for capturing the reception signal. The spatial extension of the surface may be smaller in the first direction than in the second direction. The spatial extension of the bandpass filter in the first direction may be smaller than in the second direction.

The at least one lens element is configured to optically shape the light beam of the optical reception signal. The lens element may comprise one or more lenses. A lens is a transmissive optical device which focuses or disperses a light beam by means of refraction. A lens may comprise a single piece of transparent material. A compound lens may comprise several simple lenses, e. g. arranged along a path of the light. Lenses may be made from materials such as glass or plastic and are ground, polished and/or molded to the required shape.

The bandpass filter is a transmissive optical device which may comprise a coating to selectively let pass or block certain ranges of bandwidths of electromagnetic waves.

The sensor element may comprise a surface for capturing the optical reception signal. The spatial extension of the surface may be smaller in the first direction than in a second direction. The spatial extension of the lens element in the first direction may then be larger than or equal to the spatial extension of the bandpass filter in the first direction. This allows for a reduction of the housing in the first direction, as the housing may be shaped to accommodate the bandpass filter which is at least partially of smaller dimension than the lens element.

In embodiments the field of view of the optical receiver is larger in the second direction than in the first direction. This embodiment may e. g. be used for a scanning lidar, where an optical transmit signal has a larger spatial extension in the second direction than in the first direction. The transmit signal is then gradually moved, e. g. by a reflecting element like a mirror, in the first direction to scan the scan region of the lidar system step-by-step. The reflected light is received by the optical receiver as the reception signal. The reception signal may then also have a larger extension in the second direction than in the first direction. The optical sensor element comprising the described surface dimensions is configured for such kind of reception signal. For the embodiment of a 1-dimensional scanning Lidar system, the first direction may be the horizontal direction and the second direction may be the second direction, with the scanning direction being in the horizontal. For this embodiment, the optical receiver may have a large field of view in the vertical direction, e. g. 26°, and small field of view in the horizontal direction, e. g. 0.05°.

The optical elements themselves may be of asymmetrical shape. The shape may advantageously reflect the difference in the field of view of the receiver in the first and second direction. The housing may be adapted to this asymmetry as described above, offering further advantages like a higher efficiency for the reception of the reception signal at high incident angles. The asymmetrical shape may have further advantages, e. g. in manufacturing, product yield.

In embodiments, the reception path is at least partially substantially perpendicular to the surface of the sensor element and/or to each of the first and second direction. This allows to increase the intensity of the light received by the sensor element.

The surface of the sensor element may further be substantially planar and its spatial extension the first direction may substantially be perpendicular to the second direction. In this embodiment, the sensor element may be of rectangular shape, which may be suitable for a scanning lidar system, where the scanning may be done in the first direction, e. g. the direction with the shorter dimension.

The field of view of the optical receiver in the second direction may be larger than the field of view of the optical receiver in the first direction. Such embodiments may be suitable for a scanning lidar system, where the scanning is e. g. done in the first direction with a smaller field of view, whereas the field of view of the receiver in the second direction, which is e. g. perpendicular to the scanning direction, is larger.

In certain embodiments, the spatial extension of the bandpass filter in the second direction is larger than the spatial extension of the lens element in the second direction. This allows for the bandpass filter to e. g. cover the large field of view of the receiver in the second direction. Also, such an asymmetrical shape of the bandpass filter, which may also be rectangular, allows for easier assembling at the manufacturing stage. A rectangular form instead of a round form can increase the yield of products at the manufacturing stage due to less waste of material.

In embodiments of the optical receiver, the planar body of the bandpass filter is tilted with respect to the surface of the sensor element. The tilt may help to reduce unwanted optical effects like blooming and/or ghosting, as optical reflections on the bandpass filter itself that are received by the sensor element are reduced.

A lidar system comprises an optical transmitter, a control unit, a reflecting element, e. g. a mirror, and the optical receiver as previously described.

The reflecting element may be configured to influence the incident angle of the optical receiver, e. g. by rotating and such changing the direction of a transmit signal and/or a reception signal of the lidar system. In particular, the second part of the holding element and the reflecting element may be arranged such that the intensity of the reception signal received from a high incident angle is increased compared to a housing without the reduction. This may increase the efficiency of the lidar system, in particular at large incident angles.

### BRIEF DESCRIPTION OF THE FIGURES

Embodiments will now be described with reference to the attached drawing figures by way of example only. Like reference numerals are used to refer to like elements throughout. The illustrated structures and devices are not necessarily drawn to scale.

FIG. 1 schematically illustrates an optical receiver viewed from a first side.

FIG. 2 schematically illustrates the optical receiver viewed from a second side.

FIG. 3 shows a schematical view of a sensor element.

FIG. 4 schematically illustrates the optical receiver with a reflecting element viewed from the first side.

FIG. 5 schematically shows a vehicle with a lidar system.

### DETAILED DESCRIPTION

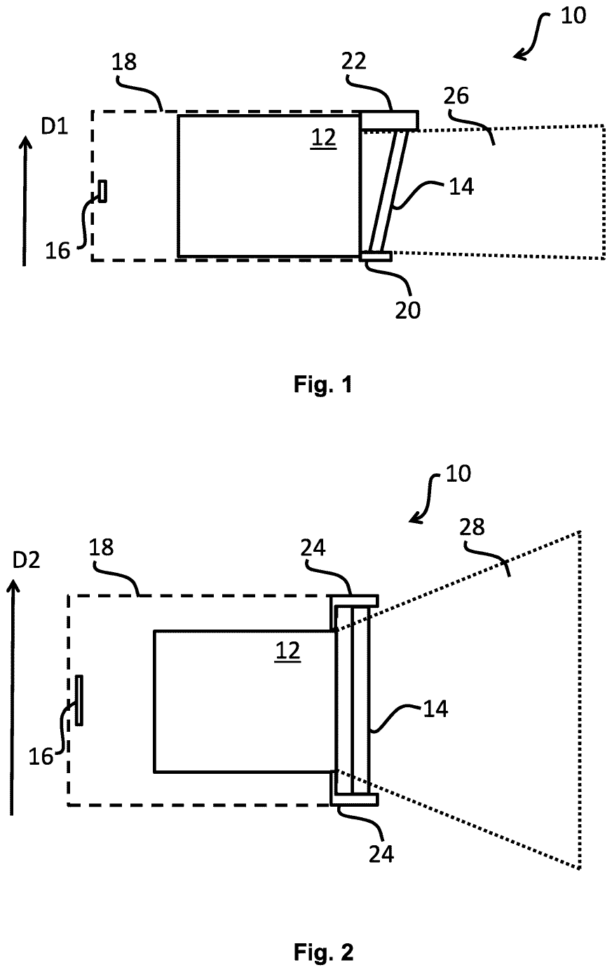

In FIG. 1 an optical receiver 10 viewed from a first side is schematically illustrated. The receiver comprises a housing 18 with a holding element comprising a first holding part 20 and a second holding part 22. The housing 18 comprises an optical sensor element 16 of the receiver 10 and optical elements 12, 14 of the receiver 10. One of the optical elements is a lens element 12, comprising at least one optical lens. Another one of the optical elements is a bandpass filter 14. The bandpass filter 14 is configured to filter an optical reception signal 32 of the receiver 10. The bandpass filter 14 may for example let a certain range of bandwidths pass and block other ranges of bandwidths.

The sensor element 16 may in particular be a photodiode, an avalanche photodiode, a photodiode line, a CCD sensor, an active pixel sensor, in particular CMOS sensor or the like.

The bandpass filter 14 has a planar body of optical transmissive material which is mechanically held by the holding element of the housing 18. The holding element holds the edges on the rim of the planar body of the bandpass filter 14. The first holding part 20 and the second holding part 22 of the holding element hold the planar body of the bandpass filter 14 at edges opposing each other in a first direction D1.

The optical receiver 10 may for example be an optical receiver 10 for a lidar system 50, the lidar system 50 further comprising an optical transmitter 52 and a control unit 58. The bandpass filter 14 may be configured to specifically let the range of bandwidths pass that are used by the lidar system 50 for object detection and ranging purposes.

As shown in FIG. 1, the bandpass filter 14 is tilted with respect to the first direction D1. With the tilted configuration, undesired optical effects like blooming and/or ghosting may be reduced. The spatial extension of the bandpass filter 14 in the first direction D1 is smaller than the spatial extension of the lens element 12. The field of view 26 of the optical receiver 10 in the first direction D1 is limited by the extension of the bandpass filter 14 in the first direction D1 and the first and second holding part 20, 22.

The thickness in the first direction of the second holding part 22 is greater than the thickness in the first direction of the first holding part 20. The length of the second holding part 22 along a reception path of the reception signal 32 is greater than the length along the reception path of the first holding part 20. Their shape is asymmetrical with respect to each other. The second holding part 22 is configured to hold the bandpass filter 14 farther away from the lens element 12 than the first holding part 20. This allows to accommodate for the tilt of the bandpass filter 14 with respect to the lens element 12.

In FIG. 2, the optical receiver 10 viewed from a second side is schematically illustrated. The holding element of the housing 18 comprises further holding parts 24, which hold the planar body of the bandpass filter 14 at edges opposing each other in a second direction D2. The length of the further holding parts 24 along the reception path is larger than the length along the reception path of both the first and the second part 20, 22.

As shown in FIG. 2, there is no tilt of the bandpass filter 14 to the second direction D2. The spatial extension of the bandpass filter 14 in the second direction D2 is larger than the spatial extension of the lens element 12. The field of view 28 of the optical receiver 10 in the second direction D2 may be larger than the field of view 26 in the first direction D1, because due to the location of the further holding parts 24 and due to the size of the bandpass filter 14, the field of view 28 in the second direction D2 is not obstructed. Also, the lens element 12 may be configured to capture a reception signal 32 which is broad in the second direction D2 and to focus it appropriately for it to be captured by the sensor element 16.

The further holding parts 24 may be symmetrical to each other. In the embodiment shown in FIGS. 1 and 2, a reduction of the housing 18 is achieved in the first direction D1, whereas in the second direction D2 the further holding parts 24 extend the housing 18 beyond the lens element 12 in order to accommodate the bandpass filter 14 which has a larger size in the second direction D2 than in the first direction D1.

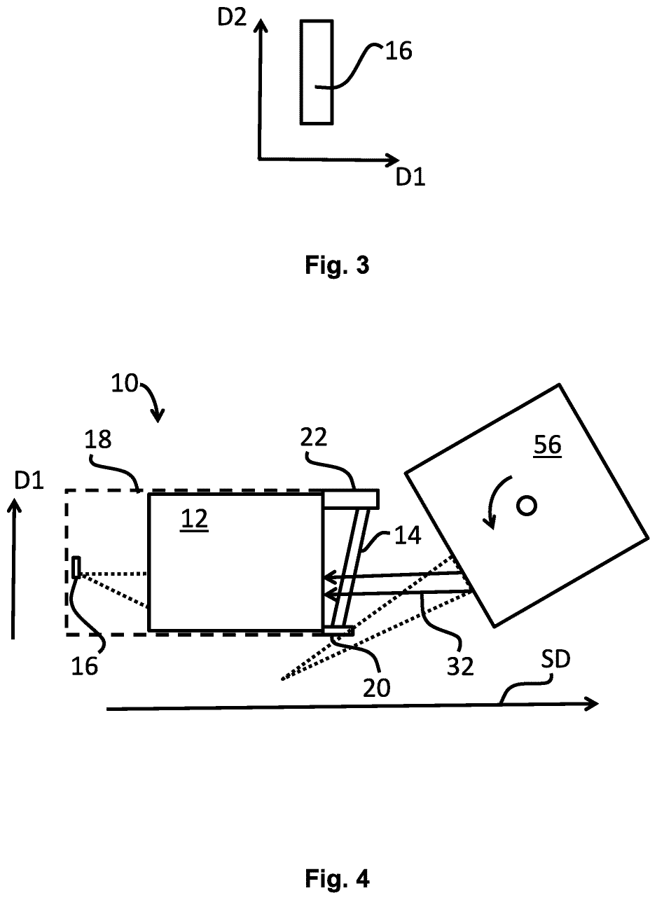

When looking at FIGS. 1 and 2, it can also be seen that the field of view 26 of the receiver 10 in the first direction D1 is smaller than the field of view 28 in the second direction D2. The spatial extension of the sensor element 16 is smaller in the first direction D1 than in the second direction D2. This is further illustrated in FIG. 3, where the sensor element 16 is shown from a direction perpendicular to the first and second direction D1, D2. The surface of the sensor element 16 may have a roughly rectangular shape. The surface may be a photosensitive surface which allows the sensor element 16 to capture incoming light.

The sensor element 16 shown in FIG. 3 has an asymmetrical shape with asymmetrical field of view 26, 28 in the first and second direction D1, D2. This asymmetry in the field of view 26, 28 may advantageously be taken into account by the bandpass filter 14, which may comprise an asymmetrical shape and/or be tilted with only one of the two directions D1, D2. The asymmetry of the bandpass filter 14 may then advantageously be taken into account by an asymmetrical shape of the holding element, thus enhancing the overall range of the system.

In FIG. 4 the optical receiver 10 viewed from the first side is schematically illustrated. The optical receiver 10 is shown with a reflecting element 56, which may for example be a rotating mirror. The reflecting element 56 may be used to deflect the optical reception signal 32 arriving from a scan region 30 of the lidar system 50.

With the rotation of the reflecting element 56, the scan region 30 of the lidar system 50 can be covered for reception as well as transmission of the optical signals. The optical reception signal 32 can be received from different incident angles of the scan region 30 in the scan direction SD successively.

As shown in FIG. 4, the reduction of the housing 18 due to the asymmetric shape of the first part 20 and second part 22 of the holding element leads to increased amount of light received by the sensor element 16 from incident angles that are farther away. The first part 20 extrudes less far than the second part 22 and it therefore lets pass more light from extremer incident angles of the scan region 30. The first part 20 may for example be closer to a front cover of the lidar system 50 than the second part 22.

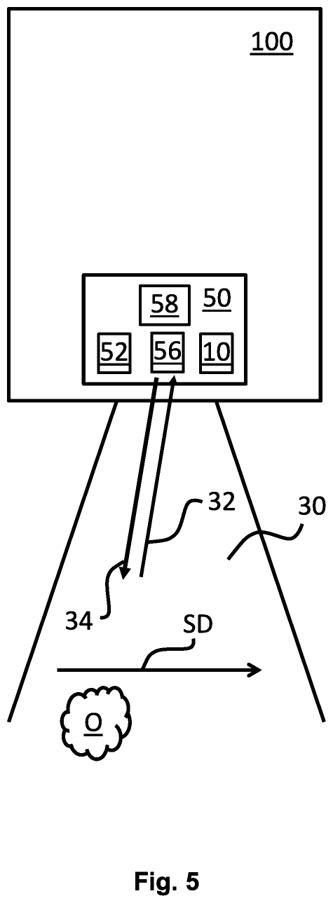

FIG. 5 schematically shows a vehicle 100, for example a passenger car. A lidar system 50 is arranged in a front area of the vehicle 100. The lidar system 50 comprises the optical transmitter 52 and the optical receiver 10. The reflecting element 56 is arranged such that transmit signals 34 emitted by the transmitter 52 and reception signals 32 received by the receiver 10 may be deflected by it.

The lidar system 50 may be used as a laser-based detection and ranging system. Such systems may use lasers, in particular diode lasers, as sources for the optical transmit signal 34. Accordingly, the receiver 10 is designed for the wavelength of the transmit signal 34 and the bandpass filter 14 is advantageously configured to let the used wavelength ranges pass and to block others. The wavelength ranges used may be visible or invisible to the human eye.

The lidar system 50 can for example be designed as a scanning lidar system. With a scan lidar system, detection areas can e. g. be scanned with pulsed laser signals, where the transmit signal 34 may be transmitted as a pulsed laser beam to be used as a scanning signal for the scan lidar system. The shape of the laser beam may be a point, a line or an area. This results in scan lidars referred to as a point scan lidar, a line scan lidar and/or an area scan lidar. The shape of the laser beam described with reference to FIGS. 1 to 4 would be a line, but other shapes are also possible.

The transmit signals 34 and the reception signals 32 may be evaluated in the control unit 58, e. g. by the execution of software code. The evaluation may comprise time-of-flight measurements for the detection of objects O in the scan region 30. The control unit 58, which may be a computing device with storage, processing unit and interfaces, can also be used to monitor and control the transmitting process in the transmitter 52, the receiving process in the receiver 10 and the rotational movement of the reflecting element 56. The scan region 30 is located in front of the front area of the vehicle 100. Thus, in the example shown, the area 30 in front of the vehicle 100 in the direction of travel can be monitored. It is also possible to arrange the lidar system 50 in other areas of the vehicle 100, for example in the rear area and/or in side areas. It is also possible to arrange several lidar systems 50 on the vehicle 100, in particular also in corner areas of the vehicle 100.

The lidar system 50 can be used to detect stationary or moving objects O, in particular vehicles, persons, animals, plants, obstacles, roadway unevenness, in particular potholes or stones, roadway boundaries, traffic signs, open spaces, in particular parking spaces, precipitation or the like, in the scan region 30.

The reflecting element 56 may be used to deflect the transmit signal 34 emitted by the optical transmitter 52 of the lidar system 50. It is possible to deflect the transmitting light beam 34 by means of the reflecting element 56 in such a way that it slides over the scan region 30 in the scan direction SD and scans it, i.e. scans it step-by-step in the scan direction SD. The transmit signal 34 emitted by the optical transmitter 52 may have a shape which is broader in the second direction D2 than in the first direction D1. In the example shown, the first direction may for example be the horizontal direction. The transmit signal 34 may therefore have a shape which is narrow in the horizontal direction, the scan direction SD, and broad in the vertical direction. It is therefore possible to cover a broad area in the vertical direction with one scan step.

The transmit signal 34 is then reflected back as a reception signal 32 by objects O in the scan region 30 and deflected by the reflecting element 56 onto the receiver 10. Reception of the reception signal 32 is then performed by the receiver 10.

The scanning of the scan region 30 therefore happens in the scan direction SD which in the example shown in FIG. 5 is horizontal with respect to the vehicle 100. In this way, a relatively large scan region 30 can be scanned in the first direction. The described housing 18 and receiver 10 further improve the efficiency of the lidar system 50 at the large incident angles at the extremes of the scan region 30.

1. A housing for optical elements of an optical receiver of a system wherein the optical elements are configured to be placed in a reception path of an optical reception signal of the optical receiver, and to influence the optical reception signal of the optical receiver, wherein the housing comprises an asymmetrical shape with at least a partial reduction such that an intensity of the reception signal received from a high incident angle is increased.

2. The housing according to claim 1, wherein the optical elements comprise an optical lens element and an optical bandpass filter, wherein the optical lens element is located in the reception path of the optical reception signal in between the optical bandpass filter and an optical sensor element of the optical receiver.

3. The housing according to claim 2, wherein the optical bandpass filter comprises a planar body and the housing further comprises a holding element, wherein the holding element is configured to hold the optical bandpass filter at edges of the planar body, wherein a first part and a second part of the holding element are located opposite each other in a first direction, wherein the first part and the second part are asymmetrical with respect to each other.

4. The housing according to claim 3, wherein the planar body is tilted with respect to the first direction and/or with respect to the reception path, and wherein an asymmetry of the holding element depends on a tilt of the planar body.

5. The housing according to claim 3, wherein the second part of the holding element is configured to hold the planar body farther away from the optical lens element than the first part of the holding element.

6. The housing according to claim 3, wherein further parts of the holding element are configured to hold the planar body of the optical bandpass filter at edges opposing each other in a second direction, wherein a spatial extension along a reception path of each of the first and the second parts is smaller than a spatial extension along a reception path of the further parts.

7. The housing according to claim 3, wherein the second part is thicker than the first part with respect to the first direction and/or wherein a spatial extension along the reception path of the second part is larger than a spatial extension along a reception path of the first part.

8. An optical receiver comprising the housing, the optical elements, and the optical sensor element according to claim 2, wherein the optical sensor element is configured to capture the optical reception signal via the optical elements placed in the reception path of the optical reception signal.

9. The optical receiver according to claim 8, wherein the optical sensor element comprises a surface for capturing the optical reception signal, wherein a spatial extension of the surface is smaller in a first direction than in a second direction, and/or wherein a spatial extension of the optical bandpass filter in a first direction is smaller than in a second direction.

10. The optical receiver according to claim 9, wherein the reception path is at least partially substantially perpendicular to the surface of the optical sensor element and/or to each of the first and second directions.

11. The optical receiver according to claim 9, wherein the surface of the optical sensor element is substantially planar, and the first direction is substantially perpendicular to the second direction.

12. The optical receiver according to claim 9, wherein a field of view of the optical receiver in the second direction is larger than a field of view of the optical receiver in the first direction.

13. The optical receiver according to claim 8, wherein a spatial extension of the optical bandpass filter in the second direction is larger than a spatial extension of the optical lens element in the second direction.

14. The optical receiver according to claim 9, wherein a planar body of the optical bandpass filter is tilted with respect to the surface of the optical sensor element.

15. A lidar system comprising an optical transmitter, a control unit, a reflecting element, and the optical receiver according to claim 8.

16. The lidar system according to claim 15, wherein the reflecting element is configured to influence an incident angle of the optical receiver, wherein the second part of the holding element and the reflecting element are arranged such that the intensity of the reception signal received from a the high incident angle is increased.
